(19) United States
(12) Patent Application Publication
(10) Pub. No.: US 2024/0256843 A1
(43) Pub. Date: Aug. 1, 2024

(54) ELECTRONIC APPARATUS FOR QUANTIZING NEURAL NETWORK MODEL AND CONTROL METHOD THEREOF

(71) Applicant: Samsung Electronics Co., Ltd., Suwon-si (KR)

(72) Inventor: Hyukjin JEONG, Suwon-si (KR)

(21) Appl. No.: 18/519,860

(22) Filed: Nov. 27, 2023

Related U.S. Application Data
(63) Continuation of application No. PCT/KR2023/016866, filed on Oct. 27, 2023.

(30) Foreign Application Priority Data
Jan. 30, 2023 (KR) 10-2023-0012016

(51) Int. Cl. G06N 3/0495

(52) U.S. Cl. CPC G06N 3/0495

(57) ABSTRACT

An electronic apparatus is provided. The electronic apparatus includes a memory, at least one processor connected to the memory and configured to control the electronic apparatus, and the processor may obtain a first neural network model comprising at least one layer that may be quantized, obtain test data used as an input of the first neural network model, obtain feature map data from each of at least one layer included in the first neural network model by inputting the test data to the first neural network model, obtain information about at least one of scaling or shifting to equalize channel-wise data from the feature map data obtained from each of the at least one layer, obtain a second neural network model in which channel-wise data of the feature map data is equalized by updating each of the at least one layer based on the obtained information, and obtain a quantized third neural network model corresponding to the first neural network model by quantizing the second neural network model based on the test data.

### CROSS-REFERENCE TO RELATED APPLICATION(S)

This application is a continuation application, claiming priority under § 365(c), of an International application No. PCT/KR2023/016866, filed on Oct. 27, 2023, which is based on and claims the benefit of a Korean patent application number 10-2023-0012016, filed on Jan. 30, 2023, in the Korean Intellectual Property Office, the disclosure of which is incorporated by reference herein in its entirety.

### BACKGROUND OF THE INVENTION

### Field of the Invention

The disclosure relates to an electronic apparatus and a control method thereof. More particularly, the disclosure relates to an electronic apparatus for quantizing a neural network model and a control method thereof.

### Description of the Related Art

With the development of electronic technology, various types of electronic apparatuses are being developed. In particular, an electronic apparatus capable of performing various calculations (or operations) has been recently developed through a neural network model.

However, in order to increase the performance of the neural network model, a capacity increase is inevitable. In particular, when a neural network model needs to be implemented on the on-device, this problem is further highlighted.

Accordingly, there is a need to develop various methods of compressing a neural network model.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic apparatus for quantizing a neural network model and a control method thereof.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes a memory, at least one processor connected to the memory and configured to control the electronic apparatus. The at least one processor is configured to obtain a first neural network model comprising at least one layer that may be quantized, obtain test data used as an input of the first neural network model, obtain feature map data from each of at least one layer included in the first neural network model by inputting the test data to the first neural network model, obtain information about at least one of scaling or shifting to equalize channel-wise data from the feature map data obtained from each of the at least one layer, obtain a second neural network model in which channel-wise data of the feature map data is equalized by updating each of the at least one layer based on the obtained information, and obtain a quantized third neural network model corresponding to the first neural network model by quantizing the second neural network model based on the test data.

In accordance with another aspect of the disclosure, a method of controlling an electronic apparatus is provided. The method includes obtaining a first neural network model comprising at least one layer that may be quantized, obtaining test data used as an input of the first neural network model, obtaining feature map data from each of at least one layer included in the first neural network model by inputting the test data to the first neural network model, obtaining information about at least one of scaling or shifting to equalize channel-wise data from the feature map data obtained from each of the at least one layer, obtaining a second neural network model in which channel-wise data of the feature map data is equalized by updating each of the at least one layer based on the obtained information, and obtaining a quantized third neural network model corresponding to the first neural network model by quantizing the second neural network model based on the test data.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A, 1B, 1C, 1D, and 1E are diagrams illustrating quantization according to various embodiments of the disclosure;

FIG. 2 is a block diagram illustrating the configuration of an electronic apparatus according to an embodiment of the disclosure;

FIG. 3 is a flowchart illustrating overall operation of a processor according to an embodiment of the disclosure;

FIG. 4 is a flowchart illustrating a method of quantizing the feature map data according to an embodiment of the disclosure;

FIG. 5 is a flowchart illustrating a method of quantizing at least one layer and feature map data according to an embodiment of the disclosure;

FIG. 6 is a block diagram illustrating a specific configuration of an electronic apparatus according to an embodiment of the disclosure;

FIG. 7 is a diagram specifically illustrating an example of application according to an embodiment of the disclosure;

FIGS. 8, 9, 10, and 11 are diagrams illustrating a method of equalizing feature map data according to various embodiments of the disclosure;

FIGS. 12 and 13 are diagrams illustrating a method of fusing a scaling configuration with a previous layer according to various embodiments of the disclosure;

FIGS. 14 and 15 are diagrams illustrating a method of fusing shifting configuration with a previous layer according to various embodiments of the disclosure;

FIG. 16 is a diagram illustrating a criterion to perform at least one of scaling or shifting according to an embodiment of the disclosure;

FIG. 17 is a block diagram illustrating overall equalization operation according to an embodiment of the disclosure;

FIG. 18 is a block diagram more specifically describing an equalization operation according to an embodiment of the disclosure;

FIG. 19 is a block diagram illustrating a method of identifying an equalization pattern according to an embodiment of the disclosure;

FIG. 20 is a block diagram illustrating a method of obtaining the feature map data according to an embodiment of the disclosure;

FIGS. 21 and 22 are block diagrams illustrating an update operation of the neural network model according to various embodiments of the disclosure;

FIGS. 23 and 24 are diagrams illustrating performance improvement according to various embodiments of the disclosure; and

FIG. 25 is a flowchart illustrating a method of controlling an electronic apparatus according to an embodiment of the disclosure.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An aspect of the disclosure is to provide an electronic apparatus for obtaining a neural network model while reducing data capacity and reducing an error attributable to quantization and a method for controlling thereof.

The disclosure will be described in greater detail with reference to the attached drawings.

The terms used in the disclosure and the claims are general terms identified in consideration of the functions of embodiments of the disclosure. However, these terms may vary depending on intention, legal or technical interpretation, emergence of new technologies, and the like of those skilled in the related art. In addition, in some cases, a term may be selected by the applicant, in which case the term will be described in detail in the description of the corresponding disclosure. Thus, the term used in this disclosure should be defined based on the meaning of term, not a simple name of the term, and the contents throughout this disclosure.

Expressions such as “have,” “may have,” “include,” “may include” or the like represent presence of corresponding numbers, functions, operations, or parts, and do not exclude the presence of additional features.

Expressions such as “at least one of A or B” and “at least one of A and B” should be understood to represent “A,” “B” or “A and B.”

As used herein, terms such as “first,” and “second,” may identify corresponding components, regardless of order and/or importance, and are used to distinguish a component from another without limiting the components.

It is to be understood that terms such as “comprise” or “consist of” are used herein to designate a presence of a characteristic, number, step, operation, element, component, or a combination thereof, and not to preclude a presence or a possibility of adding one or more of other characteristics, numbers, steps, operations, elements, components or a combination thereof.

In the following description, a “user” may refer to a person using an electronic apparatus or an artificial intelligence (AI) electronic apparatus using an electronic apparatus (e.g., artificial intelligence electronic apparatus).

Various embodiments of the disclosure will be described in more detail with reference to the accompanying drawings.

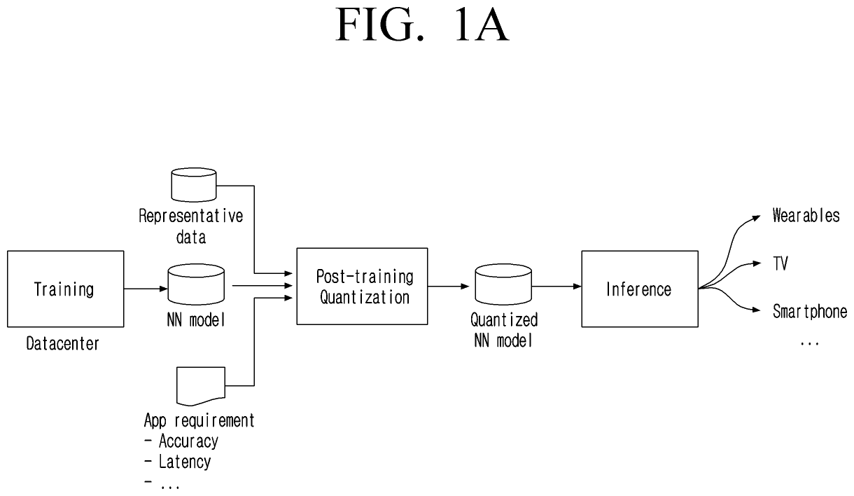

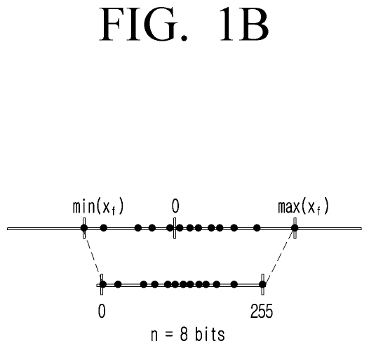

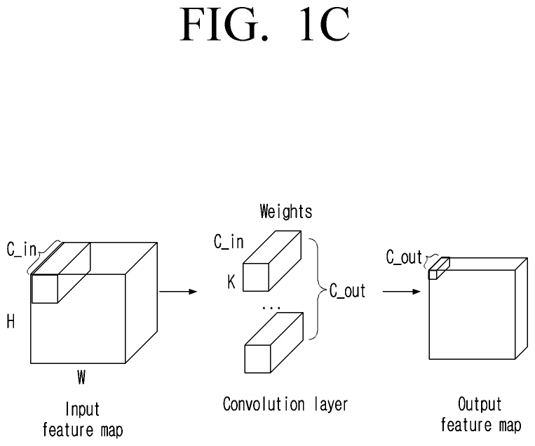

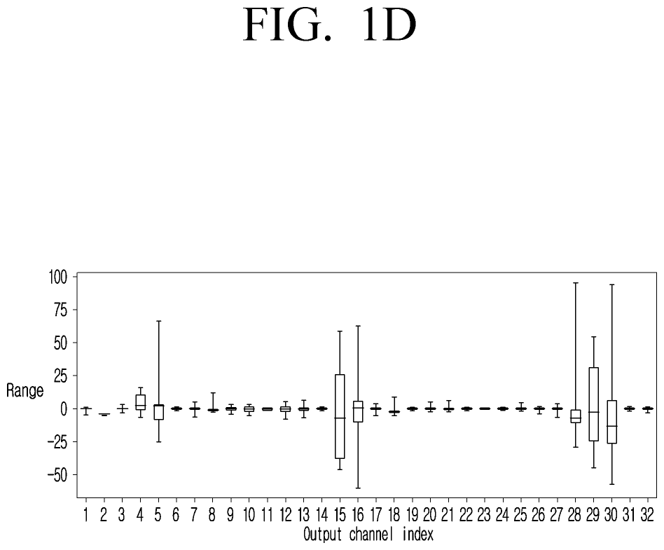

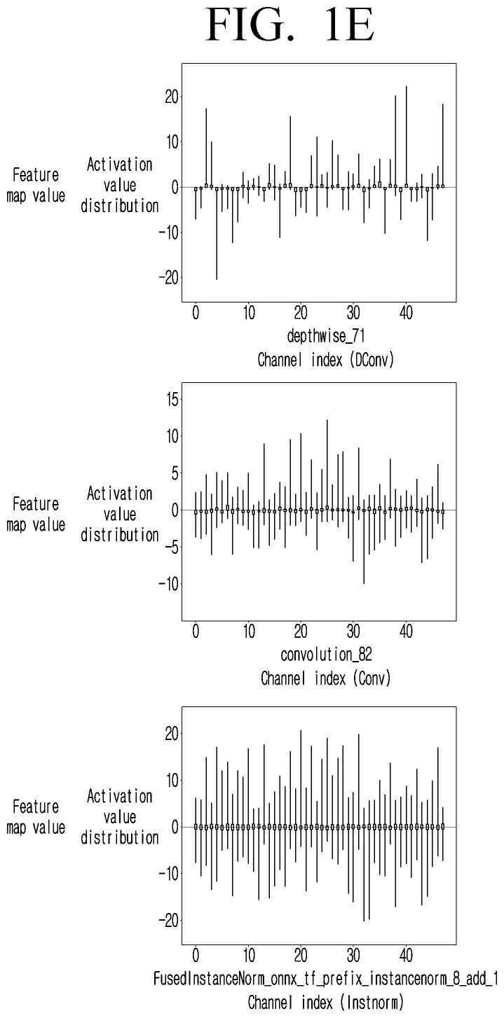

FIGS. 1A, 1B, 1C, 1D, and 1E are diagrams illustrating quantization according to various embodiments of the disclosure.

Recently, quantization has been used to increase the compression rate while minimizing the performance degradation of a neural network model. The weight quantization method may be divided into post-training quantization and quantization-aware training based on the time of quantization, and may be divided into linear quantization and non-linear quantization based on a quantization method.

In the case of the post-training quantization, referring to FIG. 1A, a neural network including a weight in a floating point type for which training has been already completed is quantized without re-training and thus is speedy and does not require learning data.

As one of the post-training quantization, affine quantization may quantize a real number value through affine transformation. For example, referring to FIG. 1B, the minimum value of x_{f} is transformed to 0, the maximum value of x^{f} is transformed to 255, as shown below.

$$xf = scale * ( xq - zero point ) \qquad Equation 1$$

$$scale = ( max ( xf ) - min ( xf ) ) / ( {2}^{∧} n - 1 ) \qquad Equation 2$$

Here, x_{f} may be an original real number value, x_{q} may be a quantized value, a scale may be a scaling magnification for quantization, zero point may be a value of X_{q} when x_{f} is 0, and n may be the number of bits.

The affine quantization is a method capable of implementing efficient hardware while degradation of accuracy is being low, but according to a range of the real number value, scale and zero point (zp) are determined, so if the range becomes different, quantization error may increase.

The quantization method may be divided into layer-wise quantization (LWQ) and channel-wise quantization (CWQ) with reference to a unit of performing quantization. The LWQ is a method of quantizing weights of one layer to the same scale and zp and CWQ is a method of quantizing weights of one layer to different scale and zp as many as the channels. For example, referring to FIG. 1C, if the input feature map is input to the convolution layer, the output feature map may be output, wherein if the convolution layer is quantized to one scale and zp, the method may be LWQ, and when the convolution layer is quantized to scales and zp by channels, the method may be CWQ.

In general, referring to FIG. 1D, there are a lot of cases where distributions of values of each channel are different, so the CWQ method is used a lot.

In the meantime, as for the feature map data, not a layer, there is a problem in that it is difficult to use the CWQ as the feature map data is merely an intermediate calculation result.

The feature map data also may have a problem in that an error may increase when quantized to one scale and zp due to different distributions of each channel value.

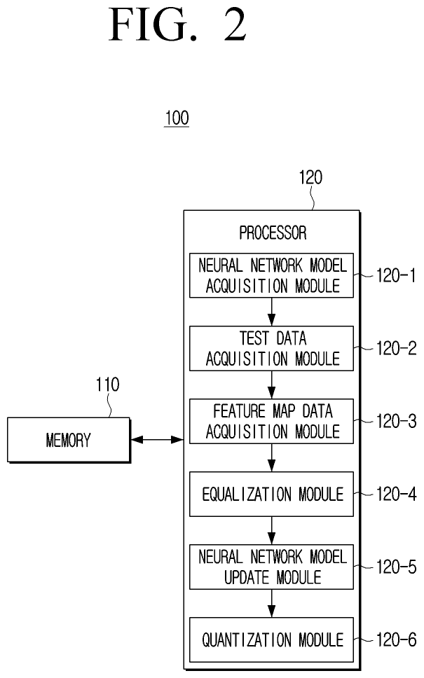

FIG. 2 is a block diagram illustrating the configuration of the electronic apparatus 100 according to an embodiment of the disclosure.

The electronic apparatus 100 may be an apparatus which quantizes a neural network model. For example, the electronic apparatus 100 may be implemented as a television (TV), a desktop personal computer (PC), a notebook PC, a video wall, a large format display (LFD), a digital signage, a digital information display (DID), a projector display, a smartphone, a tablet PC, and may quantize a neural network model. Here, the quantization is the technology of converting a weight in a floating point type to an integer, through which an error with respect to a result of the neural network model may occur, but the data capacity with respect to the neural network model may be reduced or calculation speed may increase. In the meantime, the embodiment is not limited thereto, and the electronic apparatus 100 may be any device that may quantize the neural network model.

Referring to FIG. 2, the electronic apparatus 100 includes a memory 110 and a processor 120. However, embodiments are not limited thereto, and the electronic apparatus 100 may be implemented as a type to exclude some configurations.

The memory 110 may refer to a hardware that stores information such as data as an electric or magnetic form so that the processor 120, or the like, may access, and the memory 110 may be implemented as at least one hardware among a non-volatile memory, a volatile memory, a flash memory, a hard disk drive (HDD) or solid state drive (SSD), random access memory (RAM), read-only memory (ROM), or the like.

The memory 110 may store at least one instruction used for operation of the electronic apparatus 100 or the processor 120. Here, the instruction is a code unit that directs the operation of the electronic apparatus 100 or the processor 120, and may be written in a machine language that may be understood by a computer. A plurality of instructions that perform a particular task of the electronic apparatus 100 or the processor 120 may be stored in the memory 110 as an instruction set.

In particular, the memory 110 may store data required by the module for controlling the quantization operation of the electronic apparatus 100 to perform various operations. For example, the configuration for controlling the operation of quantizing the neural network model by the electronic apparatus 100 may include the neural network model acquisition module 120-1, the test data acquisition module 120-2, the feature map data acquisition module 120-3, the equalization module 120-4, the neural network model update module 120-5, and the quantization module 120-6 of FIG. 2, and each module may be implemented in software in the memory 110. However, the embodiment is not limited thereto, and each module may be implemented in hardware as one configuration of the processor 120.

Data, which is information in bits or bytes capable of representing letters, numbers, images, etc., may be stored in the memory 110. For example, the memory 110 may store data obtained during an operation process of the processor 120. In addition, information about at least one neural network model and information about test data may be stored in the memory 110.

The memory 110 is accessed by the processor 120 and reading/writing/modifying/deleting/updating of data by the processor 120 may be performed.

The processor 120 controls overall operation of the electronic apparatus 100. To be specific, the processor 120 may be connected to each configuration of the electronic apparatus 100 and may control overall operation of the electronic apparatus 100. For example, the processor 120 may be connected to the memory 110, display (not shown), or the like, and may control the operation of the electronic apparatus 100.

The processor 120 may be implemented as at least one processor. The at least one processor may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The at least one processor may control one or any combination of other components of the electronic apparatus 100 and may perform operations or data processing relating to the communication. The at least one processor may execute one or more programs or instructions stored in the memory. For example, the at least one processor may perform a method in accordance with one or more embodiments of the disclosure by executing one or more instructions stored in the memory 110.

When a method according to one or more embodiments of the disclosure includes a plurality of operations, a plurality of operations may be performed by one processor or may be performed by a plurality of processors. For example, when a first operation, a second operation, and a third operation are performed by a method according to one or more embodiments, all of the first operation, the second operation, and the third operation may be performed by the first processor, the first operation and the second operation may be performed by a first processor (e.g., a general purpose processor), and the third operation may be performed by a second processor (e.g., an artificial intelligence dedicated processor). For example, the process of quantizing the neural network model according to one or more embodiments may be performed by a general-use processor, and a process of learning or inferring the quantized neural network model may be performed by an artificial intelligence-dedicated processor.

The at least one processor may be implemented as a single core processor including one core, or may be implemented as one or more multicore processors including a plurality of cores (for example, homogeneous multi-cores or heterogeneous multi-cores). When at least one processor is implemented as a multi-core processor, each of the plurality of cores included in the multi-core processor may include a processor internal memory such as a cache memory and an on-chip memory, and a common cache shared by the plurality of cores may be included in the multi-core processor. In addition, each of a plurality of cores (or a part of a plurality of cores) included in the multi-core processor may independently read and perform a program command for implementing a method according to one or more embodiments of the disclosure, and may read and perform a program command for implementing a method according to one or more embodiments of the disclosure in connection with all (or a part of) a plurality of cores.

When the method according to one or more embodiments of the disclosure includes a plurality of operations, the plurality of operations may be performed by one core among a plurality of cores included in the multi-core processor or may be performed by the plurality of cores. For example, when a first operation, a second operation, and a third operation are performed by a method according to one or more embodiments, all the first operation, second operation, and third operation may be performed by a first core included in the multi-core processor, and the first operation and the second operation may be performed by a first core included in the multi-core processor and the third operation may be performed by a second core included in the multi-core processor.

In the embodiments of the disclosure, the at least one processor may mean a system-on-chip (SoC), a single core processor, a multi-core processor, or a core included in a single core processor or a multi-core processor in which one or more processors and other electronic components are integrated, wherein the core may be implemented as a CPU, a GPU, an APU, a MIC, a DSP, an NPU, a hardware accelerator, or a machine learning accelerator, but embodiments of the disclosure are not limited thereto. In the meantime, for convenience of description, the operation of the electronic apparatus 100 will be described with the expression of the processor 120.

Referring to FIG. 2, that a plurality of modules are located inside the processor 120 is to indicate that a plurality of modules are loaded (or executed) by the processor 120 and operate in the processor 120, and a plurality of modules may be presorted in the memory 110.

The processor 120 may control the overall operation of the electronic apparatus 100 by executing a module or instruction stored in the memory 110. Specifically, the processor 120 may read and interpret a module or an instruction and determine a sequence for data processing, and accordingly, may control the operation of a different configuration by transmitting a control signal that controls the operation of a different configuration such as the memory 110.

The processor 120 may obtain the first neural network model by executing a neural network model acquisition module 120-1. For example, the processor 120 may receive the first neural network model from an external server and store the received first neural network model in the memory 110. Alternatively, the first neural network model is stored in the memory 110, and the processor 120 may read the first neural network model from the memory 110. Here, the first neural network model may include a plurality of layers. In this case, a plurality of layers may include a plurality of parameters (e.g., weight, bias, etc.) capable of quantization.

The processor 120 may obtain test data by executing the test data acquisition module 120-2. For example, the processor 120 may receive test data from an external server and store the received test data in the memory 110. Alternatively, the test data is stored in the memory 110, and the processor 120 may read the test data from the memory 110. Here, the test data may be data used as an input of the first neural network model. For example, the test data may be data for obtaining feature map data input to the first neural network model and output from each of at least one layer included in the first neural network model.

The processor 120 may obtain feature map data from each of at least one layer included in the first neural network model by inputting the test data to the first neural network model by executing the feature map data acquisition module 120-3. For example, the processor 120 may input test data into a first neural network model to obtain first feature map data to n^{th} feature map data from each of n layers included in the first neural network model. For convenience of description, when it is assumed that the test data is a plurality of test images, the processor 120 may obtain first feature map data to n^{th} feature map data by inputting a first test image among a plurality of test images to a first neural network model, and obtain first feature map data to n^{th} feature map data by inputting a second test image among the plurality of test images to a first neural network model. In this manner, the processor 120 may obtain first feature map data to n^{th} feature map data for all of the plurality of test images. The feature map data refers to an intermediate calculation result output from each layer included in a neural network model, and may include a data group classified for each channel included in each layer. For example, when input data is calculated from a first layer of a neural network model, first feature map data may be output, and when first feature map data is calculated with a second layer of a neural network model, second feature map data may be output. Here, when the first layer of the neural network model includes m channels, the first feature map data may be divided into m data groups, and when the second layer of the neural network model includes n channels, the second feature map data may be divided into n data groups.

Hereinafter, for convenience of description, a description will be given based on first feature map data output from a first layer among n layers included in a first neural network model. However, for the feature map data output from the remaining layer among the n layers, the same operation as the first feature map data may be performed.

The processor 120 may obtain information about at least one of scaling or shifting for equalizing data for each channel in feature map data obtained from each of at least one layer by executing the equalization module 120-4. Here, the equalization refers to an operation of equally adjusting a range of data for each channel of feature map data or minimizing an error.

For example, the processor 120 may obtain information about at least one of scaling or shifting based on a channel having a maximum range among feature map data obtained from each of at least one layer. In the above-described example, the processor 120 may obtain the first feature map data as many as the number of the plurality of test images. Here, the first feature map data may be data divided for each channel, and the processor 120 may identify a channel having a maximum range among the first feature map data obtained as many as the number of the plurality of test images. The range is a difference between a maximum value and a minimum value among data included in the channel, and the maximum range may be a range of a channel having the largest range among channels of the first feature map data obtained as many as the number of the plurality of test images. Here, scaling refers to a calculation of multiplying data for each channel by a scaling magnification. For example, when the channel data includes ten values, the processor 120 may scale the data for each channel by multiplying the scaling magnification to each of ten values. The shifting refers to a calculation of adding a shift value to data for each channel. For example, when the channel data includes ten values, the processor 120 may shift the data for each channel by adding a shift value to each of ten values.

The processor 120 may shift the range of the channel having the maximum range, and may scale and shift the range of the remaining channels based on the shifted range. Through this operation, for example, range of all channels of the first feature map may be made the same.

Alternatively, the processor 120 may perform only scaling for the first feature map data. In this case, the processor 120 may obtain information about scaling so that the range of remaining channels except the channel having the maximum range out of the first feature map data is less than the range of the channel having the maximum range out of the first feature map data by a preset value or more.

For example, when the maximum range is 10, the processor 120 may scale the range of remaining channels other than the channel having the maximum range to be 8 or less, which is smaller by 2 than 10.

According to one or more embodiments, when only scaling is performed, the processor 120 may scale one of the minimum value and the maximum value of each remaining channel to correspond to the maximum range. For example, the processor 120 may identify the first scaling magnification based on the minimum value of each of the remaining channels and the minimum value of the maximum range, identify the second scaling magnification based on the maximum value of each of the remaining channels and the maximum value of the maximum range, and may identify a smaller value between the first scaling magnification and the second scaling magnification as a final scaling magnification.

The processor 120 may obtain information about at least one of the scaling or shifting based on a type of a preceding layer and a succeeding layer of the feature map data obtained from each of at least one layer. For example, the processor 120 may, when the immediately-preceding layer of the first feature map data is the first type and the immediately-succeeding layer of the first feature map data is the second type, obtain only information about scaling, when the immediately-preceding layer of the first feature map data is the third type and the immediately-succeeding layer of the first feature map data is the fourth type, may obtain only information about the shift, and when the immediately-preceding layer of the first feature map data is the fifth type and the immediately-preceding layer of the first feature map data is the sixth type, may obtain information about the scaling and the shift.

Here, the type of layer may be determined by the calculation characteristics of the layer and whether feature map data subject to equalization is input/output. For example, if the layer is Conv and feature map data is output, scaling for the feature map data is possible. However, if the layer is Mul and feature map data is output, it is impossible to scale the feature map data. This may be expressed as MUL(X, Y) in the case of Mul, and MUL(X, Y)xa during scaling, but scaling is impossible because it cannot be expressed as a Mul operation. Alternatively, if the layer is Conv and feature map data is output, shift is possible with respect to the feature map data. However, if the layer is Mul and feature map data is output, it is impossible to shift the feature map data. The Mul may be expressed as MUL(X, Y), and MUL(X, Y)+a when shifting, but this cannot be expressed as Mul calculation, so shifting is impossible.

The processor 120 may obtain a second neural network model in which channel-wise data of the feature map data is equalized by updating each of the at least one layer based on the information about scaling or shifting by executing the neural network model update module 120-5.

For example, the processor 120 may, based on scaling the feature map data of a first layer among the at least one layer, update the first layer by multiplying channel-wise scaling data by the weight and bias of the first layer for each channel, and update the second layer by dividing the second layer that is an immediately succeeding layer of the first layer by the channel-wise scaling data for each channel.

Alternatively, the processor 120 may, based on shifting the feature map data of a third layer among the at least one layer, update the third layer by adding the channel-wise shifting data to the bias of the third layer by channels, and update the fourth layer by multiplying the channel-wise shifting data by a weight of a fourth layer immediately succeeding the third layer by channels, adding the multiplication result by channels, and subtracting the channel-wise addition result from the bias of the fourth layer.

Alternatively, the processor 120 may, based on scaling the feature map data of a fifth layer among the at least one layer, apply scaling to the feature map data of the fifth layer and apply shifting to the feature map data to which the scaling is applied.

Through this operation, the first neural network model may be updated to the second neural network model. In addition, the feature map data output from at least one layer included in the second neural network model may have a fewer deviation by channels in the same layer than the feature map data output from at least one layer included in the first neural network model. In particular, if scaling and shifting are performed for all feature map data, the feature map data output from at least one layer included in the second neural network model may have no deviation by channels in the same layer.

The processor 120 may obtain quantized third neural network model corresponding to the first neural network model by quantizing the second neural network model based on test data by executing the quantization module 120-6.

For example, the processor 120 may quantize the second neural network model through the affine transformation. The affine transformation is the quantization method like below.

$$xf = scale * ( xq - zero point ) \qquad Equation 3$$

Here, the x_{f} may be an original real number value, x_{q} may be a quantized value, scale may be a scaling magnification for quantization, and zero point may be a value of x_{q} when x_{f} is 0.

The processor 120 may quantize each of at least one layer included in the second neural network model and feature map data output from each of at least one layer through the affine transformation.

Here, the processor 120 may obtain the third neural network model by quantizing at least one channel included in the second neural network model by channels and quantizing feature map data of each of at least one data included in the second neural network model by feature map data.

Through this operation, an error that may occur in the quantization process may be reduced.

In the meantime, a function related to artificial intelligence according to the disclosure may operate through the processor 120 and the memory 110.

The processor 120 may be composed of one or a plurality of processors. At this time, the one or a plurality of processors may be a general-purpose processor such as a central processor (CPU), an application processor (AP), a digital signal processor (DSP), a graphics-only processor such as a graphics processor (GPU), a vision processing unit (VPU), an AI-only processor such as a neural network processor (NPU), or the like.

The one or more processors may control processing of the input data according to a predefined operating rule or AI model stored in the memory 110. Alternatively, if the one or a plurality of processor is an AI-only processor, the AI-only processor may be designed with a hardware structure specialized for the processing of a particular AI model. The pre-defined operational rule or AI model are made through learning

Being made through learning may refer to a predetermined operating rule or AI model set to perform a desired feature (or purpose) is made by making a basic AI model trained using various training data using learning algorithm. The learning may be accomplished through a separate server and/or system, but is not limited thereto and may be implemented in an electronic apparatus. Examples of learning algorithms include, but are not limited to, supervised learning, unsupervised learning, semi-supervised learning, or reinforcement learning.

The AI model may include a plurality of neural network layers. Each of the plurality of neural network layers includes a plurality of weight values, and may perform a neural network processing operation through an iterative operation leveraging results of a preceding layer and a plurality of weight values. The plurality of weight values included in the plurality of neural network layers may be optimized by learning results of the AI model. For example, the weight values may be updated such that a loss value or a cost value obtained by the AI model is reduced or minimized during the learning process.

The artificial neural network may include deep neural network (DNN) and may include, for example, but is not limited to, convolutional neural network (CNN), recurrent neural network (RNN), restricted Boltzmann machine (RBM), deep belief network (DBN), bidirectional recurrent deep neural network (BRDNN), generative adversarial network (GAN), deep Q-networks, or the like.

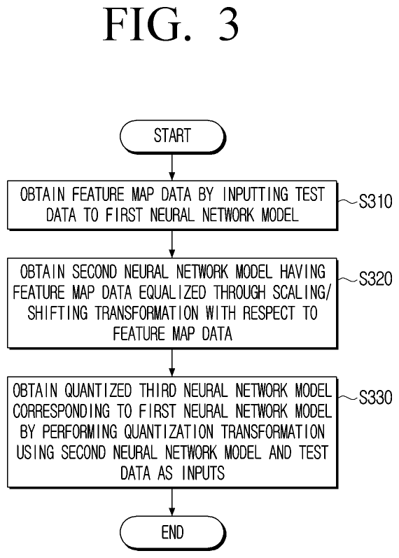

FIG. 3 is a flowchart illustrating overall operation of a processor according to an embodiment of the disclosure.

First of all, the processor 120 may obtain feature map data by inputting the test data to the first neural network model in operation S310. For convenience, if it is assumed that the first neural network model includes the first layer and the second layer, the processor 120 may obtain the feature map data output from the first layer by inputting the test data to the first neural network model. In this case, the feature map data may be divided by channels. For example, if the first layer includes ten channels, the feature map data may include ten data corresponding to each of ten channels.

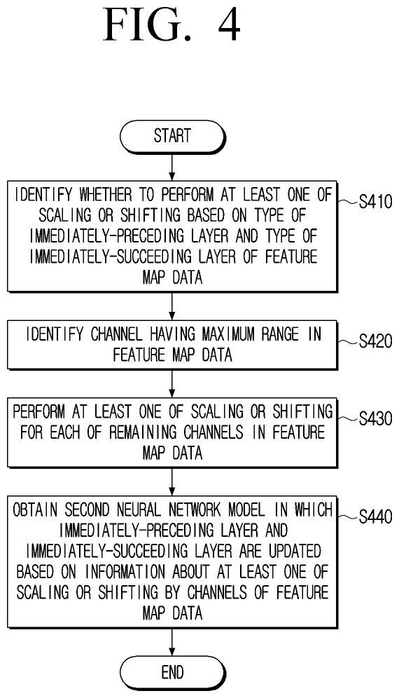

The processor 120 may obtain a second neural network model having feature map data equalized through scaling/shifting transformation with respect to the feature map data in operation S320. In the above-described example, the processor 120 may identify a range of each of ten data of the feature map data. Here, the range may be a difference between a maximum value and a minimum value of data included in each channel. The processor 120 may obtain a second neural network model by performing at least one of scaling or shifting for a range of each channel based on a maximum range having the largest value among a plurality of ranges, and updating a first layer, which is an immediately-preceding layer of feature map data, and a second layer, which is an immediately-succeeding layer of feature map data, based on an execution result. The specific operation of S320 will be described with reference to FIG. 4.

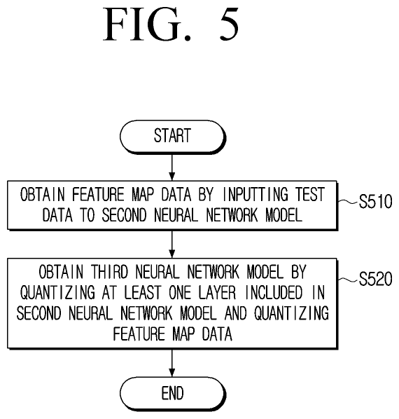

The processor 120 may obtain a quantized third neural network model corresponding to the first neural network model by performing quantization transformation using the second neural network model and test data as inputs in operation S330. In the above-described example, the processor 120 may quantize the first layer and the second layer included in the second neural network model, obtain feature map data by inputting test data into the second neural network model, and obtain the third neural network model by quantizing the feature map data. The specific operation of S330 will be described with reference to FIG. 5.

FIG. 4 is a flowchart illustrating a method of quantizing the feature map data according to an embodiment of the disclosure.

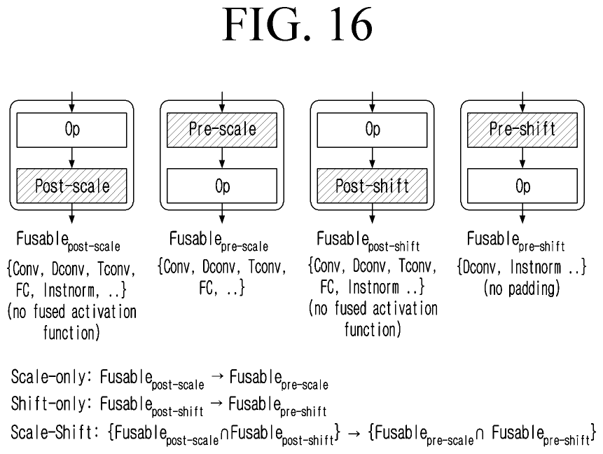

First of all, the processor 120 may identify whether to perform at least one of scaling or shifting based on a type of an immediately-preceding layer and a type of an immediately-succeeding layer of the feature map data in operation S410. For example, when the result of individually performing calculation with an immediately-preceding layer and the result after fusing the scaling calculation with the immediately-preceding layer are the same, the processor 120 may identify that scaling calculation with the immediately-preceding layer may be combined. Here, whether the immediately-preceding layer can be combined with the scaling calculation may be determined according to the calculation characteristics of the immediately-preceding layer, and a specific description will be described through FIG. 16 below. The processor 120 may identify, based on the above method, whether at least one of the scaling calculation or shifting calculation is combined with the immediately-preceding layer and whether at least one of the scaling calculation or shifting calculation is combined with an immediately-succeeding layer, and may determine whether to perform at least one of the scaling or shifting based on the result thereof.

The processor 120 may identify a channel having the maximum range in the feature map data in operation S420. For example, the processor 120 may identify the range which is the difference between the maximum value and the minimum value for each of data by a plurality of channels of the feature map data, identify the largest value as the maximum range, and identify a channel corresponding to the maximum range.

The processor 120 may perform at least one of scaling or shifting for each of the remaining channels excluding a channel corresponding to the maximum range in the feature map data in operation S430. If it is identified that the feature map data is scaled in the operation of S410, the processor 120 may scale the range of each of the remaining channels to the maximum range size or a value smaller than the maximum range by a preset value. In this case, the processor 120 may obtain the scaling magnification for each of the remaining channels.

Alternatively, if it is identified that the feature map data is shifted in operation S410, the processor 120 may shift ranges of each of the remaining channels based on a minimum value and a maximum value corresponding to the maximum range. In this case, the processor 120 may obtain a shift value for each of the remaining channels.

Alternatively, when it is identified that the feature map data is scaled and shifted in operation S410, the processor 120 may scale the range of each of the remaining channels by the size of the maximum range, and shift the scaled range of each of the remaining channels based on the minimum and maximum values of the channels corresponding to the maximum range. In this case, the processor 120 may obtain a scaling magnification and a shift value for each of the remaining channels.

The processor 120 may obtain the second neural network model in which the immediately-preceding layer and the immediately-succeeding layer are updated based on the information about at least one of the scaling or shifting by channels of the feature map data in operation S440. For example, the processor 120 may obtain the second neural network model by updating an immediately-preceding layer and an immediately-succeeding layer based on at least one of the scaling magnification or shift value by channels of the feature map data.

FIG. 5 is a flowchart illustrating a method of quantizing at least one layer and feature map data according to an embodiment of the disclosure.

First of all, the processor 120 may obtain the feature map data by inputting the test data to the second neural network model in operation S510. This operation is the same as the operation of S310 and will not be described.

The processor 120 may obtain a third neural network model by quantizing at least one layer included in the second neural network model and quantizing feature map data in operation S520. For example, when the second neural network model includes two layers, the processor 120 may quantize each of the two layers for each channel. In addition, the processor 120 may quantize feature map data output from the first of the two layers. Here, in the feature map data, data output for each channel is equalized, and the processor 120 may perform quantization on the entire feature map data rather than quantizing the feature map data for each channel.

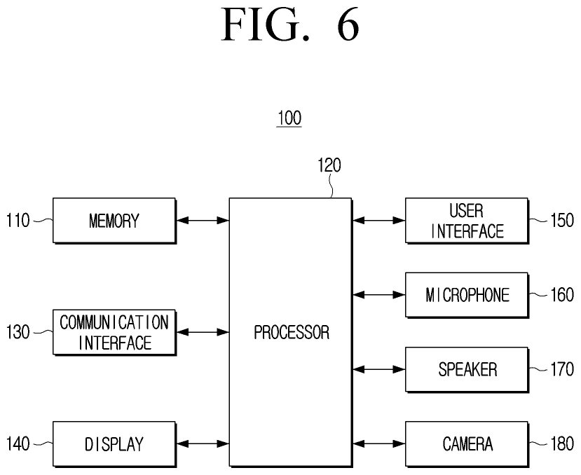

FIG. 6 is a block diagram illustrating a specific configuration of the electronic apparatus 100 according to an embodiment of the disclosure. The electronic apparatus 100 may include the memory 110 and the processor 120.

Referring to FIG. 6, the electronic apparatus 100 may further include a communication interface 130, a display 140, a user interface 150, a microphone 160, a speaker 170, and a camera 180. Among the configurations illustrated in FIG. 6, a detailed description of parts overlapping with the configurations illustrated in FIG. 2 will be omitted.

The communication interface 130 is configured to communicate with various types of external devices according to various communication methods. For example, the electronic apparatus 100 may communicate with an external server, or the like, through the communication interface 130.

The communication interface 130 may include a wireless fidelity (Wi-Fi) module, a Bluetooth module, an infrared communication module, a wireless communication module, or the like. Here, each communication module may be implemented as at least one hardware chip.

The Wi-Fi module and the Bluetooth module perform communication using a Wi-Fi method and a Bluetooth method, respectively. When using the Wi-Fi module or the Bluetooth module, various connection information such as a service set identifier (SSID) and a session key may be transmitted and received first, and communication information may be transmitted after communication connection. The infrared ray communication module may perform communication according to infrared data association (IrDA) technology that transmits data wireless to a local area using infrared ray between visible rays and millimeter waves.

The wireless communication module may include at least one communication chip performing communication according to various communication standards such as Zigbee, 3rd generation (3G), 3rd generation partnership project (3GPP), long term evolution (LTE), LTE advanced (LTE-A), 4th generation (4G), 5th generation (5G), or the like, in addition to the communication methods as described above.

Alternatively, the communication interface 130 may include a communication interface like high definition multimedia interface (HDMI), displayport (DP), Thunderbolt, universal serial bus (USB), red green blue (RGB), D-subminiature (D-SUB), digital visual interface (DVI), or the like.

The communication interface 130 may also include at least one of a local area network (LAN) module, Ethernet module, or wired communication module performing communication using a pair cable, a coaxial cable, an optical cable, or the like.

The display 140 is configured to display an image and may be implemented as various types of displays such as a liquid crystal display (LCD) panel, organic light emitting diodes (OLED) display panel, a plasma display panel (PDP), and the like. In the display 140, a driving circuit which may be implemented in a type of an a-Si thin film transistor (TFT), a low temperature poly silicon (LTPS) TFT, an organic TFT (OTFT), and a backlight may be included. In the meantime, the display 140 may be implemented as a touch screen combined with a touch sensor, a flexible display, a three-dimensional (3D) display, or the like.

The user interface 150 may be implemented as a device such as a button, a touch pad, a mouse, a keyboard, or a touch screen capable of performing the display function and operation input function. Here, the button may be various types of buttons such as a mechanical button, a touch pad, a wheel, or the like, formed in an arbitrary area such as a front portion, a side portion, a back portion, or the like, of the outer surface of the main body of the electronic apparatus 100.

The microphone 160 is configured to receive a sound and convert the sound into an audio signal. The microphone 160 is electrically connected to the processor 120 and receives a sound under the control of the processor 120.

For example, the microphone 160 may be integrally formed on an upper side, a front side direction, a side direction, or the like of the electronic apparatus 100. Alternatively, the microphone 160 may be provided in a remote controller separate from the electronic apparatus 100. In this case, the remote controller may receive sound through the microphone 160 and provide the received sound to the electronic apparatus 100.

The microphone 160 may include various configurations such as a microphone for collecting user voice in an analog format, an amplifier circuit for amplifying the collected user voice, an audio-to-digital (A/D) conversion circuit for sampling the amplified user voice to convert into a digital signal, a filter circuitry for removing a noise element from the converted digital signal, or the like.

In the meantime, the microphone 160 may be implemented with a type of a sound sensor and may be any type that may collect sound.

The speaker 170 outputs not only various audio data processed by the processor 120 but also various notification sounds or voice messages.

In addition, the electronic apparatus 100 may further include a camera 180. The camera 180 is configured to capture a still image or a moving image. The camera 180 may capture a still image at a specific time point, but may continuously capture a still image.

The camera 180 includes a lens, a shutter, an aperture, a solid-state imaging device, an analog front end (AFE), and a timing generator (TG). The shutter adjusts the time at which the light reflected by the subject enters the camera 180, and the aperture adjusts the amount of light incident on the lens by mechanically increasing or decreasing the size of an opening through which the light enters. The solid-state imaging device outputs an image by a photoelectric charge as an electric signal when the light reflected on the subject is accumulated as the photoelectric charge. TG outputs a timing signal for reading out pixel data of the solid-state imaging device, and AFE samples and digitizes the electrical signal output from the solid-state imaging device.

As described above, the electronic apparatus 100 may update the first neural network model to the second neural network model for equalizing the feature map data, and quantize the second neural network model, thereby reducing data capacity and errors due to quantization.

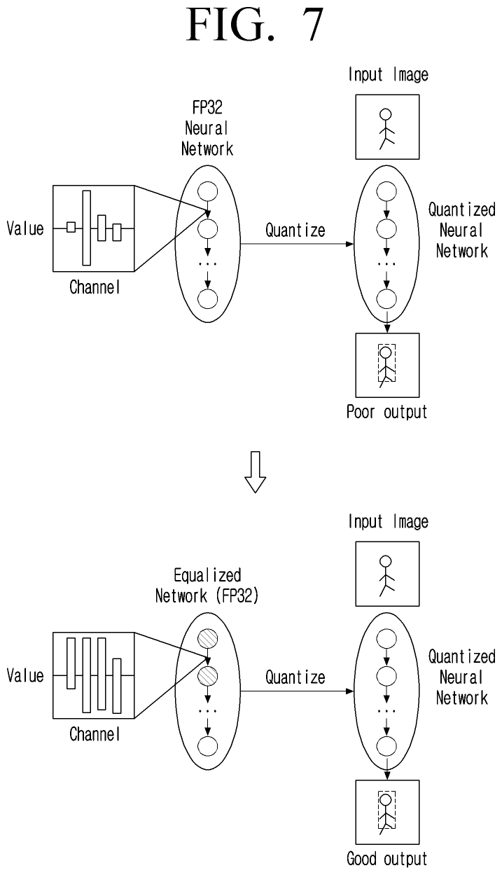

FIG. 7 is a diagram specifically illustrating an example of application according to an embodiment of the disclosure.

The feature map equalization operation of the electronic apparatus 100 as described above may have improved effect when applied to a case of having a lot of feature maps where ranges of channel-wise values are different. For example, as shown in the upper drawing of FIG. 7, the object detection model may include many feature maps having different ranges of channel-wise values (FP32 natural network). In this case, as shown in the lower drawing of FIG. 7, the electronic apparatus 100 may perform a feature map equalization operation on the object detection model to obtain a model including a feature map in which a range of channel-wise values is equalized (equalized network (FP32)), and may reduce a quantization error by using the same. Alternatively, in the case of an application that generates an image among generative models, such as a style transfer that converts an image into a cartoon, instance normalization that performs channel-wise normalization by calculating the average and standard deviation during the transformation process may be mainly used. Since the input of the instance normalization is a feature map that has not yet been normalized, the electronic apparatus 100 may perform a feature map equalization operation on the input of the instance normalization to reduce the quantization error. However, the embodiment is not limited thereto, and the electronic apparatus 100 may reduce the quantization error by performing a feature map equalization operation on various types of neural network models.

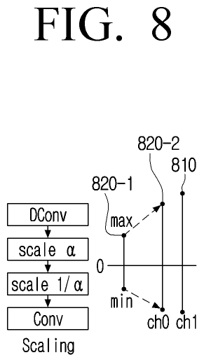

Hereinafter, the operation of the electronic apparatus 100 will be described in more detail with reference to FIGS. 8 to 24. Referring to FIGS. 8 to 24, individual embodiments will be described for convenience of description. However, the individual embodiments of FIGS. 8 to 24 may be performed in any number of combined states.

FIGS. 8, 9, 10, and 11 are diagrams illustrating a method of equalizing feature map data according to various embodiments of the disclosure.

The processor 120 may equalize the feature map data by performing at least one of scaling or shifting for channel-wise data from the feature map data.

Referring to FIG. 8, as shown on the left side of FIG. 8, the processor 120 may input feature map data output from the DConv layer to a Conv layer. Here, the processor 120 may scale the feature map data to alpha (a), and may scale the feature map data to 1/a again, and the feature map data input to the Conv layer may be the same as when the feature map data input to the Conv layer is not scaled according to the two scaling processes. In the left side of FIG. 8, for convenience of description, it is illustrated that the feature map data is scaled to a and is scaled again to 1/a, but in the actual scaling process, scaling magnification may be different for each channel of feature map data. In addition, a channel having a maximum range from among channels of feature map data may have a scaling magnification of 1.

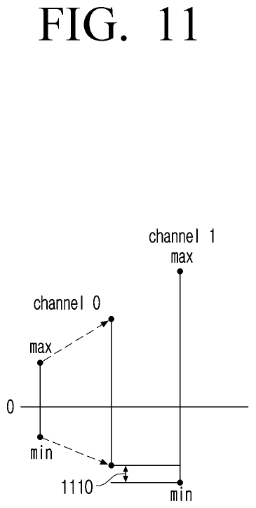

The processor 120 may identify a channel having a maximum range among a plurality of channels included in the feature map data, and obtain information about scaling the remaining channels among the plurality of channels based on the maximum range. For example, in the right side of FIG. 8, it is illustrated that channel 1 (ch1, 810) is a channel having a maximum range, and one channel 820-1 of the remaining channels is shown. The processor 120 may obtain information about scaling the channel 820-1 to channel 0 (ch0, 820-2) based on the channel 1 810. A method by which the processor 120 scales the channel 0 820-2 based on the channel 1 810 will be described later with reference to FIG. 11.

The processor 120 may obtain information for scaling each of the remaining channels among a plurality of channels by the method in the right of FIG. 8.

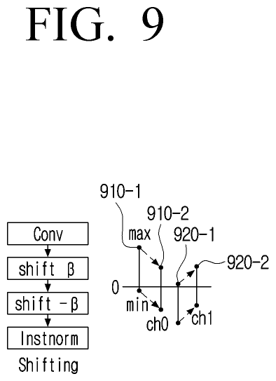

Referring to FIG. 9, as shown on the left side of FIG. 9, the processor 120 may input feature map data output from the Conv layer into the Instnorm layer. Here, the processor 120 may shift the feature map data to β, shift the feature map data back to −β, and the feature map data input to the Instnorm layer may be the same as when the feature map data is not shifted by having two shifting processes. On the left side of FIG. 9, for convenience of description, it is shown to shift to β and then to −β, but in the actual shifting process, the shift value of the feature map data may be different for each channel.

The processor 120 may obtain information about shifting so that the average value of the maximum value and the minimum value of each of a plurality of channels included in the feature map data to be zero. For example, As shown on the right side of FIG. 9, the processor 120 may obtain information about shifting the channel 910-1 to channel 0 (ch0 and 910-2) and information about shifting the channel 920-1 to channel 1 (ch1 and 920-2).

The processor 120 may obtain information for shifting each of the plurality of channels the method in the right of FIG. 8.

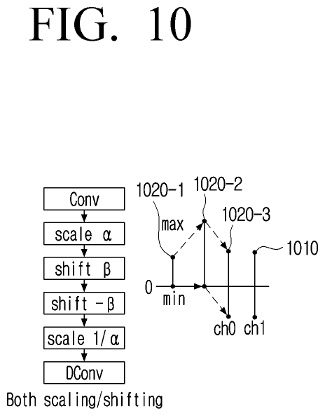

Referring to FIG. 10, the processor 120 may input feature map data output from the Conv layer into the DConv layer, as shown on the left side of FIG. 10. Here, the processor 120 may scale the feature map data to a, shift to β, shift back to −β, and scale back to 1/a, and the feature map data input to the DConv layer as it goes through two scaling and two shifting processes may be the same as when it does not go through a scaling and shifting process. On the left side of FIG. 10, for convenience of description, it is shown that the scaling magnification is a and the shift value is β, but in the actual scaling and shifting process, the scaling magnification and the shift value may be different for each channel of the feature map data. In addition, a channel having a maximum range among channels of feature map data may have a scaling magnification of 1.

The processor 120 may identify a channel having a maximum range among a plurality of channels included in the feature map data, and obtain information about scaling and shifting the remaining channels among the plurality of channels based on the maximum range. For example, on the right side of FIG. 10, channel 1 (ch1 and 1010) is a channel having a maximum range, and one of the remaining channels 1020-1 is shown. The processor 120 may obtain information about scaling the channel 1020-1 to the channel 1020-2 based on channel 1 1010, and may obtain information about shifting the channel 1020-2 to the channel 1020-3. Here, the average values of the maximum value and the minimum value of the channel 1020-3 may be zero. That is, the processor 120 may obtain information about shifting the maximum value and the average value of the minimum value of the channel 1020-2 to zero.

The processor 120 may obtain information about scaling and shifting each of the remaining channels among the plurality of channels in the manner as the right side of FIG. 10. Alternatively, the processor 120 may obtain information about shifting so that the average value of the maximum value and the minimum value of the channel having the maximum range is to be zero, and obtain information about scaling and shifting each of the remaining channels among the plurality of channels in the same manner as the right side of FIG. 10 based on the channel having the shifted maximum range.

A configuration such as scaling, shifting, and the like added between two layers in FIGS. 8 to 10 may be combined with two layers so that performance overhead may not occur. For example, a configuration of scaling to a in FIG. 8 is combined with a DConv layer, and a configuration of scaling to 1/a may be combined with a Conv layer, and a fusing operation will be described with reference to the accompanying drawings.

As an embodiment, when performing scaling, the processor 120 may obtain information about scaling so that the range of remaining channels other than the channel having the maximum range among the feature map data is smaller than a range of the channel having the maximum range among the feature map data by a preset value or more.

Referring to FIG. 11, the processor 120 may obtain information about scaling so that channel 0 is smaller than channel 1 having the maximum range by 1110.

This operation is an operation assuming that more extreme data is input than test data for obtaining feature map data. For example, while being in the state that the feature map data is quantized based on channel 1, which is the maximum range, feature map data may include a channel having a range greater than channel 1 during the operating process of the actual neural network model, and in this case overflow may occur. Accordingly, it is possible to prevent overflow in the actual neural network operating process by setting a margin greater than or equal to a preset value.

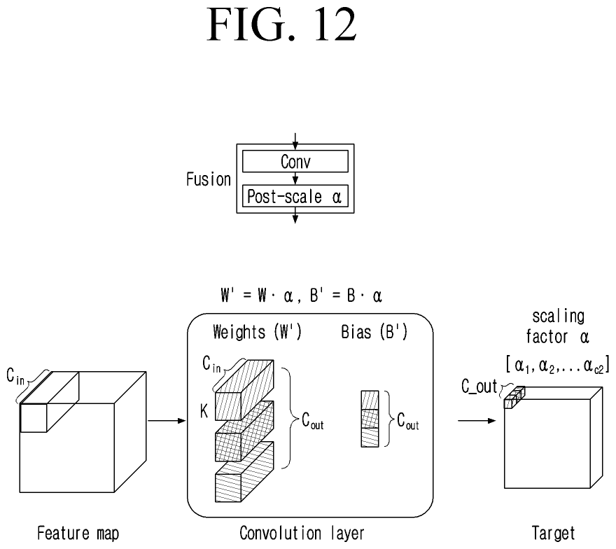

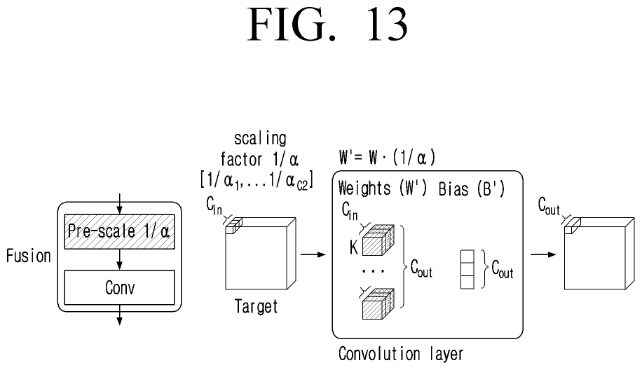

FIGS. 12 and 13 are diagrams illustrating a method of fusing a scaling configuration with a previous layer according to various embodiments of the disclosure.

The processor 120 may obtain the second neural network model in which the channel-wise data of the feature map data is equalized by updating the preceding layer and the succeeding layer based on the information about scaling.

Referring to FIG. 12, when the processor 120 scales feature map data output from a first layer (Conv layer), the processor 120 may update the first layer by multiplying the weight and bias of the first layer for each channel, as shown in FIG. 12, and may update the second layer by dividing a second layer (Conc layer) into which feature map data is input for each channel as scaling data for each channel, as shown in FIG. 13. Through this operation, feature map data output through the updated first layer may be equalized. That is, the range of each of the plurality of channels included in the feature map data output through the updated first layer may be similar range or all may have the same range.

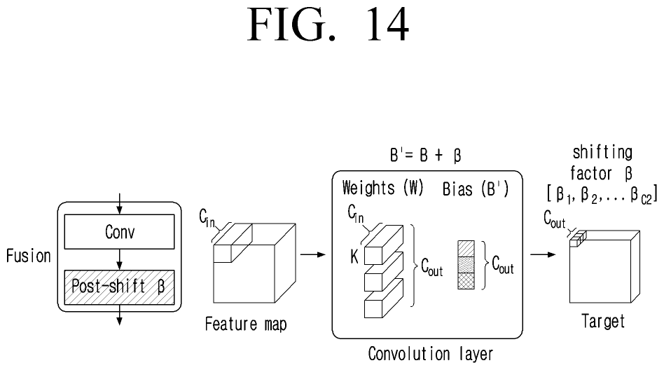

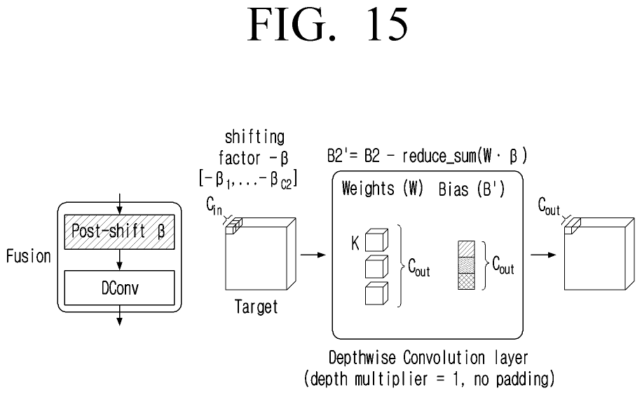

FIGS. 14 and 15 are diagrams illustrating a method of fusing shifting configuration with a previous layer according to various embodiments of the disclosure.

Referring to FIG. 14, when the processor 120 shifts the feature map data output from the third layer (Conv layer), the processor 120 may update the third layer by adding the channel-wise shift data to the bias of the third layer for each channel, and referring to FIG. 15, the processor 120 may multiply the channel-wise shift data by the weight of the fourth layer (DConv layer), add the multiplication result for each channel, and subtract an addition result for each channel to the bias of the fourth layer to update the fourth layer, as shown in FIG. 15. Through this operation, feature map data output through the updated third layer may be equalized. That is, the range of each of the plurality of channels included in the feature map data output through the updated third layer may have a similar range or all may have the same range.

Referring to FIGS. 12 to 15, it is described that only scaling is performed and only shifting is performed. When scaling and shifting are performed, the processor 120 may update the layer for outputting feature map data as shown in FIG. 12 and then further update the updated layer as shown in FIG. 14. In addition, when scaling and shifting are performed, the processor 120 may update the layer for receiving feature map data as shown in FIG. 13 and then further update the updated layer as shown in FIG. 15.

Through this operation, the first neural network model may be updated to the second neural network model. In addition, feature map data output from at least one layer included in the second neural network model may have a smaller variation for each channel in the same layer than feature map data output from at least one layer included in the first neural network model. In particular, when scaling and shifting are performed on all feature map data, feature map data output from at least one layer included in the second neural network model may not have variation by channels within the same layer.

FIG. 16 is a diagram illustrating a criterion to perform at least one of scaling or shift according to an embodiment of the disclosure.

Referring to the first drawing of FIG. 16, the processor 120 may obtain the information about scaling, if the layer (operator Op) outputting the feature map data is Conv, Dconv, Tconv, FC, Instnorm, or the like.

Referring to the second drawing of FIG. 16, the processor 120 may obtain the information about scaling, if the layer receiving the feature map data is Conv, Dconv, Tconv, FC, or the like.

When the layer outputting the feature map data is one of Conv, Dconv, Tconv, FC, or Instnorm, it is expressed that f(x)xa=f (x). Here, f(x) indicates calculation of a layer, and a indicates a scaling magnification.

For example, Instnorm IN(x) about x may be represented as below.

$$IN ( x ) = γ ( \frac{x - μ ( x )}{σ ( x )} ) + β \qquad Equation 4$$

$${μ}_{nc} ( x ) = \frac{1}{HW} {\sum }_{h = 1}^{H} {\sum }_{w = 1}^{W} {X}_{nchw} \qquad Equation 5$$

$${o}_{nc} ( x ) = \sqrt{\frac{1}{HW} {\sum }_{h = 1}^{H} {\sum }_{w = 1}^{W} {( {x}_{nchw} - {μ}_{nc} ( x ) )}^{{2}_{+}} ε} \qquad Equation 6$$

When the layer IN(x) outputting the feature map data is updated with magnification a, it is as shown below.

$$IN ( x ) \times a = γ \times a ( \frac{x - μ ( x )}{σ ( x )} ) + β \times a \qquad Equation 7$$

That is, the processor 120 may update IN(x) to the scaling magnification a by changing gamma(γ) to gamma x a and beta(β) to beta x a. That is, IN(x)xa=IN′(x) is established, where IN′(x) represents an IN calculation in which gamma and beta, which are parameters of IN(x), are multiplied by a. The IN′(x) after the update may still be in the form of an Instnorm calculation.

As the third drawing of upper side of FIG. 16, the processor 120 may obtain information about shift when the layer outputting the feature map data is Conv, Dconv, Tconv, FC, Instnorm, or the like.

The processor 120 may, as the fourth drawing of the upper side of FIG. 16, obtain information about shift when the layer receiving the feature map data is Dconv, Instnorm, or the like.

When the layer receiving the feature map data is one of Conv, Dconv, Tconv, and FC, it is expressed that f(ax)=f (x). Here, f(x) represents calculation of a layer and a represents scaling magnification. In the meantime, as for Instnorm, f(ax)=f (x) is not established, so update is not possible.

For example, update of the layer IN(x) receiving the feature map data by the scaling magnification a may be represented as below.

$$IN ( ax ) = γ ( \frac{ax - {μ}^{′}}{{σ}^{′}} ) + β \qquad Equation 8$$

Here, mu(μ)′ represents an average of ax, sigma(σ)′ represents standard deviation of ax+epsilon, and epsilon is a very small number to prevent the standard deviation from being 0.

It is represented that mu′(average of ax)=a×mu, sigma′(standard deviation of ax+epsilon)=√((a×standard deviation)\hat{ }2+epsilon), but due to epsilon included in sigma′, sigma′ may not be represented as sigma. Accordingly, transformation of IN(ax) to a format of Instnorm calculation is not possible, and consequently, a layer may not be updated.

In the meantime, when Dconv is a layer for receiving feature map data, both a scaling calculation and a shift calculation are possible. For example, Dconv is expressed as WxX+B, where W is weights, X is input, and B is bias. In this case, when the Dconv receiving the feature map data is combined with the scaling calculation, it is expressed as WxaX+B and may be expressed as W′xX+B(W′=Wxa), and fusing with the scaling calculation is available. Alternatively, Dconv, which receives feature map data, is expressed as a(WxX+B) and may be expressed as W′xX+B(W′=Wxa, B′=Bxa) when combined with the shift calculation so that fusing with the shift calculation is available.

As described above, according the calculation characteristics and update method (fusing method) of each layer, whether update is possible may be determined.

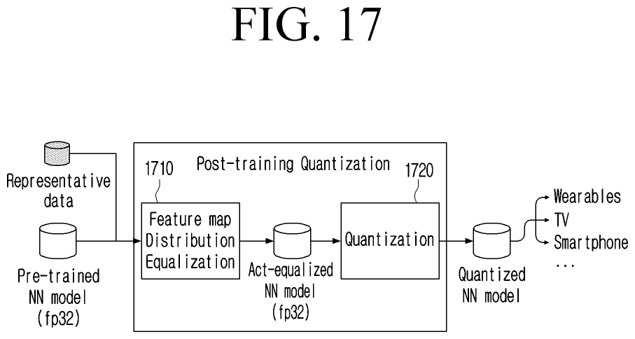

FIG. 17 is a block diagram illustrating overall equalization operation according to an embodiment of the disclosure.

Referring to FIG. 17, the processor 120 may obtain feature map data from each of at least one layer included in the first neural network model by inputting the test data (representative data) to the first neural network model (pre-trained NN model (fp32). Here, the first neural network model is a model which is primarily trained, and as a model prior to quantization, may include a floating point type weight.

The processor 120 may obtain information about at least one of scaling or shift for equalizing data for each channel from feature map data obtained from each of at least one layer, and update each of the at least one layer based on the obtained information to obtain a second neural network model (act-equalized NN model (fp32)) in which data for each channel of feature map data is equalized at operation 1710. An operation of obtaining information about at least one of scaling or shift for equalizing has been described with reference to FIGS. 8 to 11 and 16. The second neural network model is a model in which a layer is updated through FIGS. 12 to 15, and may still include a weight in the form of a floating point.

The processor 120 may obtain quantized third neural network model (quantized NN model) corresponding to the first neural network model by quantizing the second neural network model (quantization, 1720) based on the test data.

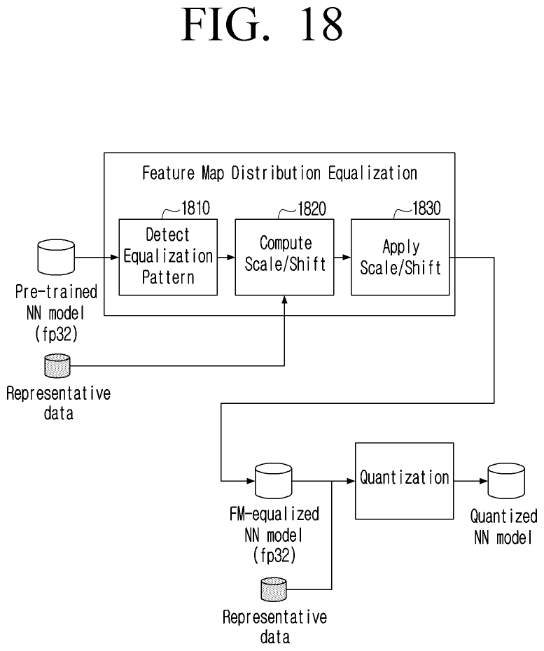

FIG. 18 is a block diagram more specifically describing an equalization operation according to an embodiment of the disclosure.

The processor 120 may identify an equalization pattern of the feature map data output from each of a plurality of layers based on an adjacent layer among a plurality of layers included in the first neural network model (detect equalization pattern, 1810).

For example, the processor 120 may identify the equalization pattern of feature map data output from the first layer as scaling if the first layer among the plurality of layers included in the first neural network model is a Conv layer and the second layer immediately after the first layer is the Conv layer.

Alternatively, if the third layer of a plurality of layers included in the first neural network model is a Conv layer and the fourth layer immediately after the third layer is a Dconv layer, the processor 120 may identify the equalization pattern of feature map data output from the third layer as scaling and shifting.

The processor 120 may obtain information about at least one of scaling or shift for equalizing data for each channel in feature map data output from each of a plurality of layers included in a first neural network model based on the identified equalization pattern (compute scale/shift, 1820). Here, the processor 120 may input test data into a first neural network model to obtain feature map data.

For example, when it is identified that feature map data output from a first layer among a plurality of layers included in a first neural network model is scaled, the processor 120 may identify a channel having a maximum range among channels included in the feature map data, and may obtain information about scaling the remaining channels based on the maximum range.

The processor 120 may update each of at least one layer based on information about at least one of scaling or shift and may obtain the second neural network model in which channel-wise data of the feature map data is equalized (apply scale/shift, 1830).

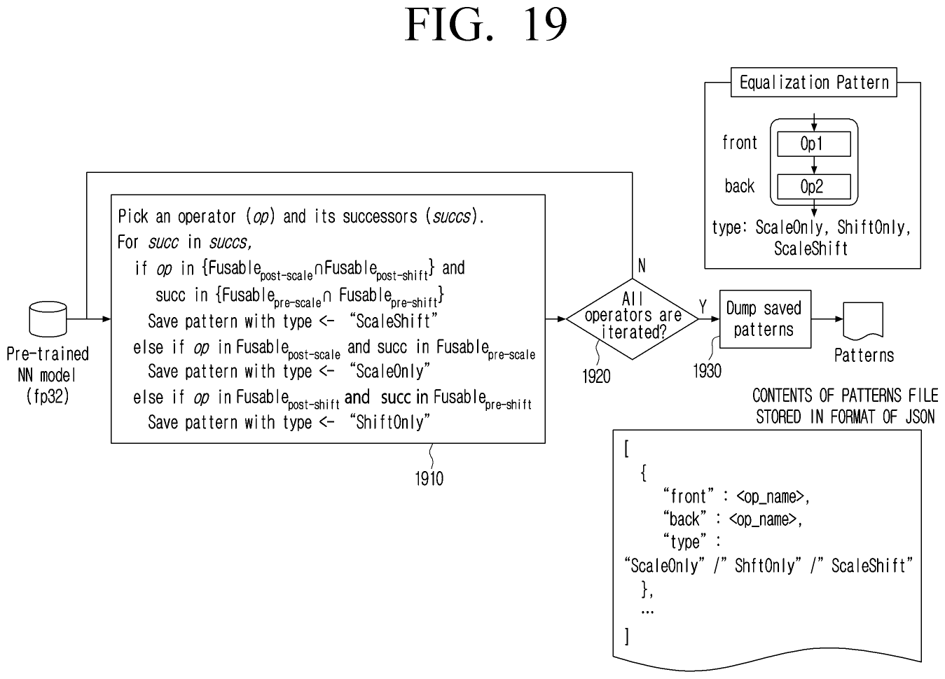

FIG. 19 is a block diagram illustrating a method of identifying an equalization pattern according to an embodiment of the disclosure.

Referring to FIGS. 8 to 10, the performance when performing both scaling and shift may be better than the performance when performing only scaling or only shift.

Referring to FIG. 19, the processor 120 may identify whether an adjacent layer among a plurality of layers included in the first neural network model may perform both scaling and shifting, and if it is not possible, identify whether only scaling may be performed, and if it is not possible, identify whether only shifting may be performed (1910).

When an equalization pattern for all adjacent layers among a plurality of layers included in the first neural network model is identified (1920), the processor 120 may store each equalization pattern (1930). For example, the processor 120 may store a layer for outputting feature map data as a “front”, store a layer for receiving feature map data as a “back”, and store the equalization type as one of ScaleOnly, ShiftOnly, and ScaleShift.

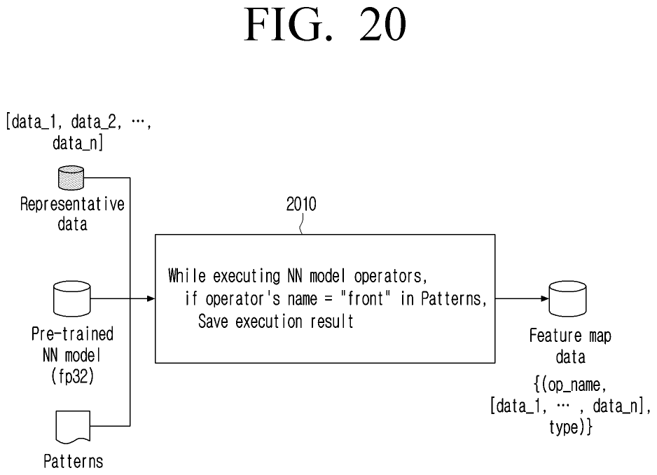

FIG. 20 is a block diagram illustrating a method of obtaining the feature map data according to an embodiment of the disclosure.

The processor 120 may obtain feature map data by inputting the test data to the first neural network model (2010).

For example, the processor 120 may input test data into a first neural network model and store data output from a layer stored as “front” as feature map data together with a layer corresponding to “front”.

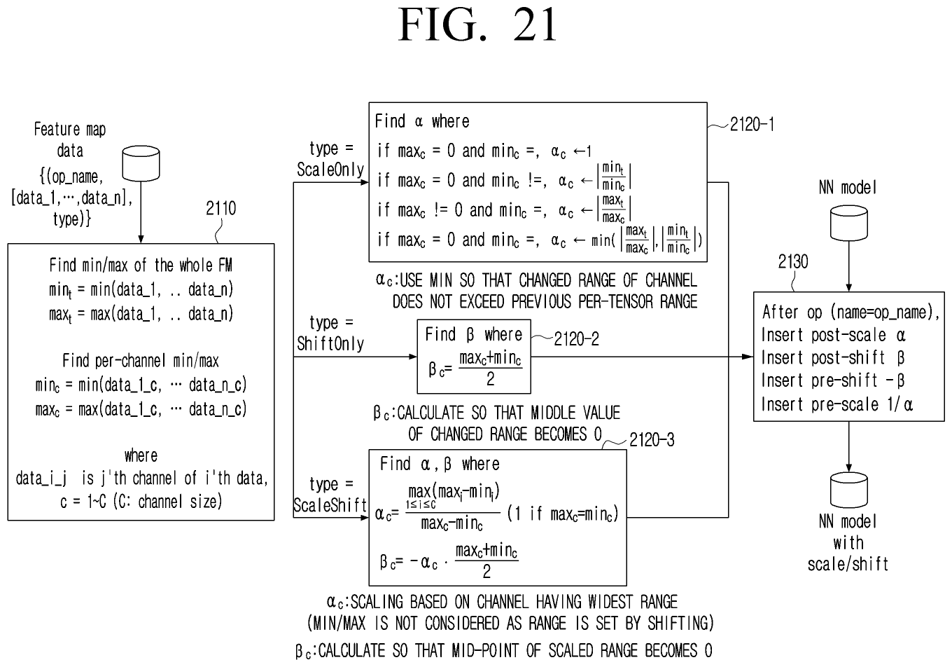

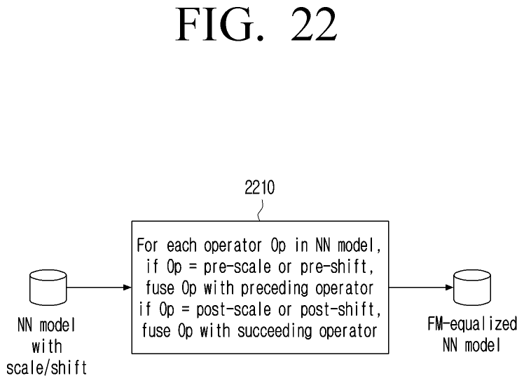

FIGS. 21 and 22 are block diagrams illustrating an update operation of the neural network model according to various embodiments of the disclosure.

The processor 120 may identify a channel having a maximum range from the entire feature map data, as illustrated in FIG. 21, identify a minimum value (min_t) and a maximum value (max_t) of a channel having the maximum range, and identify a minimum value (min_c) and a maximum value (max_c) of the individual channel (2110).

When only scaling is performed on the feature map data, the processor 120 may identify a scaling multiple of individual channels based on a minimum value and a maximum value of a channel having a maximum range (2120-1). For example, if both the minimum and maximum values of the channel having the maximum range are 0, the processor 120 may identify 1 as a scaling multiple, if the minimum value of the channel having the maximum range is 0 and the maximum value is not 0, identify a scaling multiple based on the maximum value of the channel having the maximum range and the maximum value of the individual channel, if the maximum value of the channel having the maximum range is 0 and the minimum value is not 0, identify a scaling multiple based on the minimum value of the channel having the maximum range and the minimum value of the individual channel, and if both the minimum value and the maximum value of the channel having the maximum range are not 0, may identify a scaling multiple based on a minimum value and a maximum value of the channel having the maximum range, and a minimum value and a maximum value of an individual channel.

When performing only shifting for the feature map data, the processor 120 may identify the shift value based on the minimum value and the maximum value of individual channels (2120-2).

The processor 120 may, when performing scaling and shifting for feature map data, identify the scaling multiple based on the minimum value and the maximum value of the channel having the maximum range, and may identify the shift value based on the scaling multiple, the minimum value and the maximum value of the individual channels (2120-3).

The processor 120 may update an immediately preceding layer and an immediately succeeding layer based on at least one of the scaling multiple or the shift value (2130).

Referring to FIG. 22, when at least one of scaling or shifting is performed on the feature map data, the processor 120 may fuse the first operator with the immediately preceding layer and directly fuse a second operator corresponding to the first operator with the immediately succeeding layer. Here, the first operator may be determined based on at least one of a scaling or a shifting performed in the feature map data (2210).

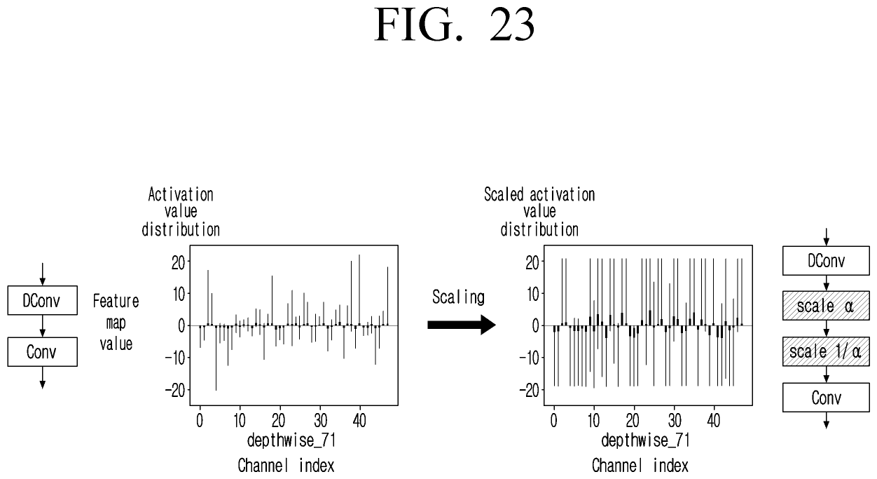

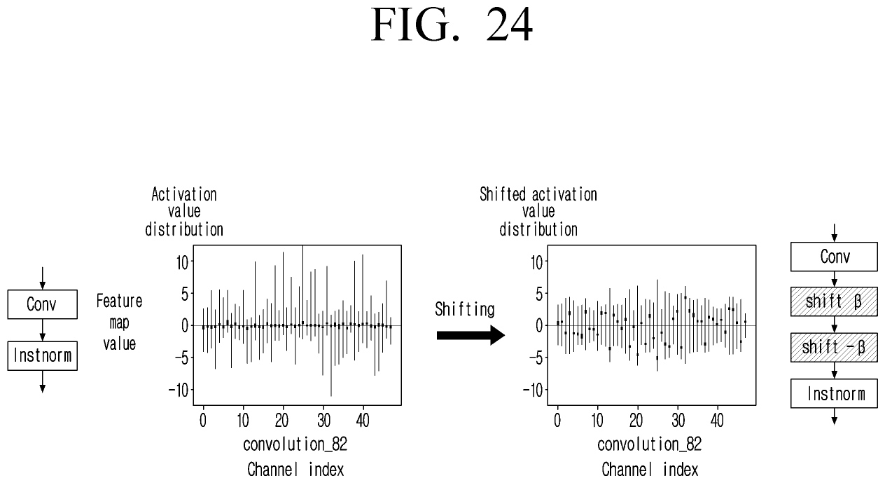

FIGS. 23 and 24 are diagrams illustrating performance improvement according to various embodiments of the disclosure.

FIG. 23 illustrates a case in which the left side is an original and the right side performs scaling only, and FIG. 24 illustrates a case in which the left side is an original and the right side performs only shifting.

As for the feature map data distribution, right is more uniform than the left, and the error due to quantization may be reduced accordingly.

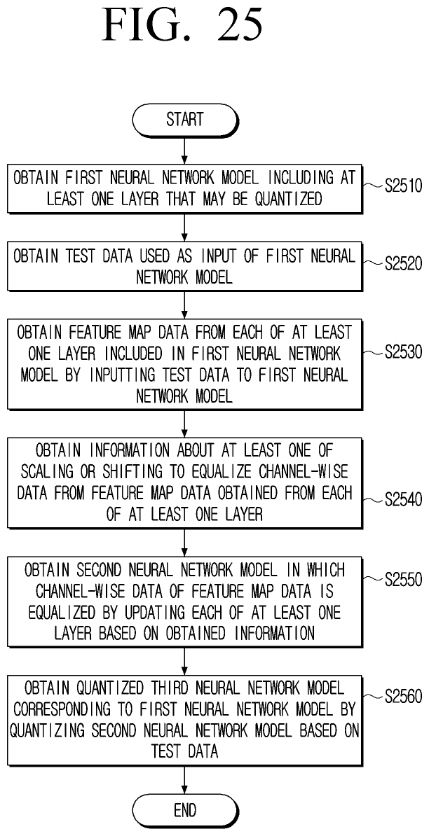

FIG. 25 is a flowchart illustrating a method of controlling an electronic apparatus according to an embodiment of the disclosure.

First of all, a first neural network model including at least one layer that may be quantized is obtained in operation S2510. In addition, test data used as an input of the first neural network model is obtained in operation S2520. In addition, the feature map data is obtained from each of at least one layer included in the first neural network model by inputting the test data to the first neural network model in operation S2530. The information about at least one of scaling or shifting is obtained to equalize channel-wise data from the feature map data obtained from each of the at least one layer in operation S2540. The second neural network model in which channel-wise data of the feature map data is equalized is obtained by updating each of the at least one layer based on the obtained information in operation S2550. In addition, a quantized third neural network model corresponding to the first neural network model is obtained by quantizing the second neural network model based on the test data in operation S2560.

The obtaining information about at least one of scaling or shifting in operation S2540 may include obtaining information about at least one of the scaling or the shifting based on a type of a preceding layer and a succeeding layer of the feature map data obtained from each of the at least one layer.

The obtaining the second neural network model in operation S2550 may include, based on scaling the feature map data of a first layer among the at least one layer, updating the first layer by multiplying channel-wise scaling data by the weight and bias of the first layer for each channel, and updating the second layer by dividing the second layer that is an immediately succeeding layer of the first layer by the channel-wise scaling data for each channel.

The obtaining the second neural network model in operation S2550 may include, based on shifting the feature map data of a third layer among the at least one layer, updating the third layer by adding the channel-wise shifting data to the bias of the third layer by channels, and updating the fourth layer by multiplying the channel-wise shifting data by a weight of a fourth layer immediately succeeding the third layer by channels, adding the multiplication result by channels, and subtracting the channel-wise addition result from the bias of the fourth layer.

The obtaining the second neural network model in operation S2550 may include, based on scaling the feature map data of a fifth layer among the at least one layer, applying scaling to the feature map data of the fifth layer and applying shifting to the feature map data to which the scaling is applied.

The obtaining information about at least one of scaling or shifting in operation S2540 may include obtaining information about at least one of the scaling or the shifting based on a channel having a maximum range among the feature map data obtained from each of the at least one layer.

The obtaining the second neural network model in operation S2550 may include, for each of the at least one layer, shifting a range of a channel having the maximum range, and scaling or shifting a range of remaining channels based on the shifted range.

The obtaining information about at least one of scaling or shifting in operation S2540 may include, based on scaling the feature map data of the first layer among the at least one layer, obtaining information about the scaling so that a range of remaining channels other than a channel having the maximum range, among the feature map data of the first layer, is smaller by a preset value or more than a range of a channel having the maximum range among the feature map data of the first layer.

The obtaining the third neural network model in operation S2560 may include obtaining the third neural network model by quantizing at least one layer included in the second neural network model by channels and quantizing feature map data of each of the at least one layer included in the second neural network model by feature map data.

The obtaining the third neural network model in operation S2560 may include quantizing the second neural network model through affine transformation.

According to the various embodiments above, the electronic apparatus may reduce errors due to quantization while reducing data capacity by updating the first neural network model to the second neural network model to equalize the feature map data and quantizing the second neural network model.

In the meantime, it has been described that the electronic apparatus quantizes a neural network model, but is not limited thereto. For example, the electronic apparatus may update the first neural network model to obtain a second neural network model, and the server may quantize the second neural network model to obtain a third neural network model.

In addition, it has been described that the electronic apparatus performs equalization and quantization, but the electronic apparatus may perform only equalization. For example, the electronic apparatus may obtain test data used as an input of the first neural network model, obtain feature map data from each of at least one layer included in the first neural network model by inputting the test data to the first neural network model, obtain information about at least one of scaling or shifting to equalize channel-wise data from the feature map data obtained from each of the at least one layer, obtain a second neural network model in which channel-wise data of the feature map data is equalized by updating each of the at least one layer based on the obtained information. That is, the electronic apparatus may perform equalization for a neural network model, not a model related to quantization.

In the meantime, according to one or more embodiments, various embodiments of the disclosure may be implemented in software, including instructions stored on machine-readable storage media readable by a machine (e.g., a computer). An apparatus may call instructions from the storage medium, and execute the called instruction, including an electronic apparatus (for example, electronic apparatus A) according to the embodiments herein. When the instructions are executed by a processor, the processor may perform a function corresponding to the instructions directly or by using other components under the control of the processor. The instructions may include code generated by a compiler or code executable by an interpreter. A machine-readable storage medium may be provided in the form of a non-transitory storage medium. Herein, the term “non-transitory” denotes that a storage medium does not include a signal, but is tangible and does not distinguish the case in which data is semi-permanently stored in a storage medium from the case in which data is temporarily stored in a storage medium.

According to one or more embodiments, the methods according to various embodiments herein may be provided in a computer program product. A computer program product may be exchanged between a seller and a purchaser as a commodity. A computer program product may be distributed in the form of a machine-readable storage medium (e.g., compact disc read only memory (CD-ROM)) or distributed online through an application store (e.g. PlayStore™) directly between two user devices (e.g., smartphones). In the case of on-line distribution, at least a portion of the computer program product may be stored temporarily or at least temporarily in a storage medium such as a manufacturer's server, a server of an application store, or a memory of a relay server.

According to one embodiment of the disclosure, the various example embodiments described above may be implemented in a recordable medium which is readable by computer or a device similar to computer using software, hardware, or the combination of software and hardware. In some cases, embodiments described herein may be implemented by the processor itself. According to a software implementation, embodiments such as the procedures and functions described herein may be implemented as separate software. Each of the above-described software modules may perform one or more of the functions and operations described herein.

The computer instructions for performing the processing operations of the device according to the various embodiments described above may be stored in a non-transitory computer-readable medium. The computer instructions stored in this non-transitory computer-readable medium cause the above-described specific device to perform the processing operations of the device according to the above-described various embodiments when executed by the processor of the specific device. The non-transitory computer readable medium may refer, for example, to a medium that stores data, such as a register, a cache, a memory or etc., and is readable by a device. For example, the aforementioned various applications, instructions, or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

According to various embodiments, the respective elements (e.g., module or program) of the elements mentioned above may include a single entity or a plurality of entities. According to the embodiments, at least one element or operation from among the corresponding elements mentioned above may be omitted, or at least one other element or operation may be added. Alternatively or additionally, a plurality of components (e.g., module or program) may be combined to form a single entity. In this case, the integrated entity may perform functions of at least one function of an element of each of the plurality of elements in the same manner as or in a similar manner to that performed by the corresponding element from among the plurality of elements before integration. The module, a program module, or operations executed by other elements according to variety of embodiments may be executed consecutively, in parallel, repeatedly, or heuristically, or at least some operations may be executed according to a different order, may be omitted, or the other operation may be added thereto.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
a memory; and
at least one processor connected to the memory and configured to control the electronic apparatus;
wherein the at least one processor is configured to:
obtain a first neural network model comprising at least one layer that may be quantized,
obtain test data used as an input of the first neural network model,
obtain feature map data from each of at least one layer included in the first neural network model by inputting the test data to the first neural network model,
obtain information about at least one of scaling or shifting to equalize channel-wise data from the feature map data obtained from each of the at least one layer,
obtain a second neural network model in which channel-wise data of the feature map data is equalized by updating each of the at least one layer based on the obtained information, and
obtain a quantized third neural network model corresponding to the first neural network model by quantizing the second neural network model based on the test data.

2. The electronic apparatus of claim 1, wherein the at least one processor is further configured to obtain information about at least one of the scaling or the shifting based on a type of a preceding layer and a succeeding layer of the feature map data obtained from each of the at least one layer.

3. The electronic apparatus of claim 1, wherein the at least one processor is further configured to: in a case of obtaining the information about the scaling, based on scaling the feature map data of a first layer among the at least one layer:
update the first layer by multiplying channel-wise scaling data by a weight and a bias of the first layer for each channel, and
update a second layer by dividing the second layer that is an immediately succeeding layer of the first layer by the channel-wise scaling data for each channel.

4. The electronic apparatus of claim 1, wherein the at least one processor is further configured to: in a case of obtaining the information about the shifting, based on shifting the feature map data of a third layer among the at least one layer:
update the third layer by adding the channel-wise shifting data to a bias of the third layer by channels, and
update a fourth layer by multiplying the channel-wise shifting data by a weight of a fourth layer immediately succeeding the third layer by channels, adding the multiplication result by channels, and subtracting the channel-wise addition result from a bias of the fourth layer.

5. The electronic apparatus of claim 1, wherein the at least one processor is further configured to, in a case of obtaining the information about the scaling and the shifting, based on scaling the feature map data of a fifth layer among the at least one layer:
apply scaling to the feature map data of the fifth layer, and
apply shifting to the feature map data to which the scaling is applied.

6. The electronic apparatus of claim 1, wherein the at least one processor is further configured to obtain information about at least one of the scaling or the shifting based on a channel having a maximum range among the feature map data obtained from each of the at least one layer.

7. The electronic apparatus of claim 6, wherein the at least one processor is further configured to, in a case of obtaining the information about the scaling and the shifting, for each of the at least one layer:
shift a range of a channel having the maximum range, and
scale or shift a range of remaining channels based on the shifted range.

8. The electronic apparatus of claim 6, wherein the at least one processor is further configured to, in a case of obtaining the information about the scaling, based on scaling the feature map data of a first layer among the at least one layer, obtain information about the scaling so that a range of remaining channels other than a channel having the maximum range, among the feature map data of the first layer, is smaller by a preset value or more than a range of a channel having the maximum range among the feature map data of the first layer.

9. The electronic apparatus of claim 1, wherein the at least one processor is further configured to obtain the third neural network model by:
quantizing at least one layer included in the second neural network model by channels, and
quantizing feature map data of each of the at least one layer included in the second neural network model by feature map data.

10. The electronic apparatus of claim 1, wherein the at least one processor is further configured to quantize the second neural network model through affine transformation.

11. A method of controlling an electronic apparatus, the method comprising:
obtaining a first neural network model comprising at least one layer that may be quantized;
obtaining test data used as an input of the first neural network model;
obtaining feature map data from each of at least one layer included in the first neural network model by inputting the test data to the first neural network model;
obtaining information about at least one of scaling or shifting to equalize channel-wise data from the feature map data obtained from each of the at least one layer;
obtaining a second neural network model in which channel-wise data of the feature map data is equalized by updating each of the at least one layer based on the obtained information; and
obtaining a quantized third neural network model corresponding to the first neural network model by quantizing the second neural network model based on the test data.

12. The method of claim 11, wherein the obtaining of information about at least one of scaling or shifting comprises obtaining information about at least one of the scaling or the shifting based on a type of a preceding layer and a succeeding layer of the feature map data obtained from each of the at least one layer.

13. The method of claim 11, wherein the obtaining the second neural network model comprises, in a case of obtaining the information about the scaling, based on scaling the feature map data of a first layer among the at least one layer:
updating the first layer by multiplying channel-wise scaling data by a weight and a bias of the first layer for each channel; and
updating a second layer by dividing the second layer that is an immediately succeeding layer of the first layer by the channel-wise scaling data for each channel.

14. The method of claim 11, wherein the obtaining the second neural network model comprises, in a case of obtaining the information about the shifting, based on shifting the feature map data of a third layer among the at least one layer:
updating the third layer by adding the channel-wise shifting data to a bias of the third layer by channels; and
updating a fourth layer by multiplying the channel-wise shifting data by a weight of a fourth layer immediately succeeding the third layer by channels, adding the multiplication result by channels, and subtracting the channel-wise addition result from a bias of the fourth layer.

15. The method of claim 11, wherein the obtaining the second neural network model comprises, in a case of obtaining the information about the scaling and the shifting, based on scaling the feature map data of a fifth layer among the at least one layer:
applying scaling to the feature map data of the fifth layer; and
applying shifting to the feature map data to which the scaling is applied.

16. The method of claim 11, wherein the obtaining of the information about at least one of scaling or shifting comprises detecting an equalization pattern from the obtained feature map data.

17. The method of claim 16,
wherein the at least one layer comprises a plurality of layers, and
wherein the detecting of the equalization pattern from the obtained feature map data comprises:
comparing each of the plurality of layers with an adjacent layer among the plurality of layers; and
determining the equalization pattern based on whether the compared layers are of a convolution layer type, a deconvolution layer type, or a combination of the convolution layer type and the deconvolution layer type.
